(19) United States
(12) Patent Application Publication
(10) Pub. No.: US 2012/0170904 A1
(43) Pub. Date: Jul. 5, 2012

(54) OPERATION ASSISTANCE APPARATUS AND OPERATION ASSISTANCE METHOD

(76) Inventor: Naohisa Tanabe, Osaka (JP)

(21) Appl. No.: 13/496,220

(22) PCT Filed: Jun. 14, 2011
(86) PCT No.: PCT/JP2011/003357

§ 371 Date: Mar. 15, 2012

(30) Foreign Application Priority Data
Jun. 18, 2010 (JP) 2010-139919

(51) Int. Cl. H04N 5/775

(52) U.S. Cl. 386/230; 386/E05.07

(57) ABSTRACT

An operation assistance apparatus (100) includes: an operation screen generating unit (102) generating an operation screen according to a user operation; an operation assistance video recording unit (106) recording the operation screen to generate video data, and to store the video data in a storage unit (108), if the operation screen is shared with the communications terminal (150); a display control unit (111) causing a display unit (103) to provide the operation screen; and an operation assistance video reproducing unit (110) reading video data corresponding to the operation screen from the storage unit (108) if the operation screen is not shared with the communications terminal (150), and reproducing the read image data. If the operation screen is not shared with the communications terminal (150), the display control unit (111) causes the display (103) to simultaneously provide the operation screen and an operation assistance video which the reproduced video data shows.

### TECHNICAL FIELD

The present invention relates to an operation assistance apparatus and an operation assistance method for assisting a user who is to be assisted (hereinafter referred to as assistance recipient) when the assistance recipient carries out an operation via an operation screen.

### BACKGROUND ART

Recently, home use devices including home electrical appliances have become more sophisticated and complex. This trend gives assistance recipients who are short of operational skills, such as the elderly, a harder time operating such devices.

One of the techniques to overcome the problem is to connect an operation screen, which works as a graphical user interface (GUI) for operating a device, with a communications terminal via a network, and to share the operation screen with the terminal. Such a technique allows a user who operates the communications terminal (hereinafter referred to as assistant) to remotely control the device via the operation screen, and to assist the operation of the assistance recipient.

In some cases, however, the assistance recipient cannot thoroughly learn how to operate the device unless he or she receives the above operation assistance several times. Such cases inevitably cause the operation screen to be shared via the network more often, resulting in an increase in communication load.

To overcome such a problem, a technique has been proposed to record an operation screen to generate video data when the screen is shared, and to store the generated video data into a storage unit (See Patent Literature 1, for example). The technique disclosed in Patent Literature 1 is capable of reproducing video data which previously holds an operation screen to display a video (hereinafter referred to as operation assistance video) for assisting the operation of an assistance recipient. This allows the assistance recipient to check the operation details again. As a result, the operation screen does not have to be shared so often via the network for receiving an operation assistance for a certain operation, which contributes to decreasing in communication load.

### Citation List

### [Patent Literature]

### [PTL 1]

Japanese Unexamined Patent Application Publication No. 2005-208883

### SUMMARY OF INVENTION

### Technical Problem

For the assistance recipient, it is difficult to find the video data for assisting a desired operation himself among previously recorded video data. This problem causes fruitless processing, including reproducing unnecessary video data or sharing an operation screen with the communications terminal even though the storage unit has already stored the video data for assisting the desired operation, which inevitably increases mechanical and communication loads.

The present invention is conceived in view of the above problem and has an object to provide an operation assistance apparatus which efficiently assists an assistance recipient to reduce mechanical and communication loads.

### Solution to Problem

In order to solve the above problems, an operation assistance apparatus according to an aspect of the present invention includes a screen sharing unit that transmits data of an operation screen to a communications terminal so as to share the operation screen with the communications terminal. The operation screen works as a graphical user interface (GUI). The screen sharing unit is connected with the communications terminal via a network. The operation assistance apparatus includes: a screen generating unit which generates the operation screen according to a user operation received via an input unit; a video recording unit which records the operation screen to generate video data, and to store the video data in a storage unit, in the case where the operation screen is shared with the communications terminal; a display control unit which causes a display unit to provide the operation screen; and a video reproducing unit which retrieves video data corresponding to the operation screen from among the video data stored in the storage unit by the video recording unit, and to reproduce the retrieved video data, in the case where the operation screen is not shared with the communications terminal, wherein in the case where the operation screen is not shared with the communications terminal, the display control unit causes the display unit to simultaneously provide the operation screen and an operation assistance video which the reproduced video data shows.

In the case where the operation screen is not shared with the communications terminal, the operation assistance apparatus can automatically cause the display unit to provide, depending on the current operation screen, an operation assistance video recorded when an operation screen was previously shared with a communications terminal. Accordingly, the operation assistance apparatus can effectively assist an assistance recipient. As a result, the operation assistance apparatus successfully avoids providing an operation assistance video which is unrelated with the current operation screen, and reduces a mechanical load. Furthermore, the operation assistance apparatus can prevent the communications terminal from sharing the operation screen when video data corresponding to the current operation screen has already been stored in order to reduce a communication load.

Preferably, the operation assistance apparatus may include an operation information recording unit which stores operation information in the storage unit in association with the generated video data, the operation information showing details of an operation carried out to the operation screen, wherein the video reproducing unit may further read from the storage unit the operation information corresponding to the retrieved video data, and when causing the display unit to provide the operation assistance video, the display control unit may cause the display unit to provide the operation information read by the video reproducing unit.

This feature allows the operation assistance apparatus to cause the display unit to simultaneously provide the operation information and the operation assistance video. Accordingly, the operation assistance apparatus can assist the assistance recipient more efficiently, contributing to further reduction in mechanical and communication load.

The input unit may be a touch panel and may provide, as the operation information, information indicating a touch location on a touch area of the touch panel.

This feature allows the operation assistance apparatus to cause the display unit to provide a touch location on the touch panel as the operation information. Accordingly, the operation assistance apparatus can effectively assist the assistance recipient when the operation screen is operated via the touch panel, contributing to further reduction in mechanical and communication load.

The display control unit may cause the display unit to provide the operation information by having a predetermined operation image overlap an area found in the operation assistance video and corresponding to the touch location indicated with the operation information, so that a time when the operation information is provided and a time when the operation screen is recorded synchronize with each other.

This feature allows the operation assistance apparatus to cause the display unit to provide the operation image so that the operation image overlaps the operation assistance video based on the touch location indicated with the operation information. Accordingly, the operation assistance apparatus can virtually replicate an operation carried out by the assistance recipient and directed to the touch panel when the operation screen is shared. Hence, the assistance recipient can carry out a desired operation by moving his or her hand according to the move of the operation image. Thus, the operation assistance apparatus can efficiently assist the assistance recipient, contributing to further reduction in mechanical and communication load.

The input unit is a remote controller having multiple operation keys, and may provide, as the operation information, information for specifying an operation key which a user operates among the operation keys.

This feature allows the operation assistance apparatus to cause the display unit to provide information for specifying an operation key as the operation information. Accordingly, the operation assistance apparatus can effectively assist the assistance recipient when the operation screen is operated via the remote controller, contributing to further reduction in mechanical and communication load.

The display control unit may cause the display unit to provide the operation information by causing the display unit to provide an operation image showing the operation key specified by the operation information, so that a time when the operation information is provided and a time when the operation screen is recorded synchronize with each other.

This feature allows the operation assistance apparatus to cause the display unit to provide the operation image showing the operated operation key so that the operation image and the operation assistance video are provided, synchronizing with each other. Thus, by sequentially operating the operation keys that the operation image shows, the assistance recipient can carry out an operation for a desired function. Hence, the operation assistance apparatus can efficiently assist the assistance recipient, contributing to further reduction in mechanical and communication load.

In the case where the video reproducing unit reads multiple pieces of the video data, the display control unit may cause the display unit to simultaneously provide the operation screen and multiple operation assistance videos shown by the pieces of the video data.

Thus, when multiple operations can be carried out to the operation screen, this feature allows the operation assistance apparatus to cause the display unit to simultaneously provide multiple operation assistance videos recorded when the operations, that are different from each other, are carried out. Hence, the operation assistance apparatus can efficiently assist the assistance recipient, contributing to further reduction in mechanical and communication load.

In the case where the video reproducing unit reads multiple pieces of the video data, the display control unit may cause the display unit to simultaneously provide the operation screen and multiple operation assistance videos shown by the pieces of the video data so that the operation assistance videos are sequentially provided.

Thus, in the case where multiple operations can be carried out to the operation screen, this feature allows the operation assistance apparatus to cause the display unit to simultaneously provide multiple operation assistance videos recorded when the operations, that are different from each other, are carried out. Hence, the operation assistance apparatus can display multiple operation assistance videos without significantly reducing an area in which the operation screen is to be displayed. Accordingly, the operation assistance apparatus can efficiently assist the assistance recipient.

The operation assistance apparatus may include an input unit which receives from the user an operation for changing a reproduction status of the operation assistance video provided on the display unit, and the video reproducing unit which changes a reproduction status of the video data according to the received operation for changing the reproduction status.

This feature allows the input unit to receive an operation directed to the operation assistance video. Thus, the assistance recipient can change the reproduction status of the operation assistance video. Hence, the operation assistance apparatus can efficiently assist the assistance recipient, contributing to further reduction in mechanical and communication load.

The display control unit may cause the display unit to simultaneously provide the operation screen and the operation assistance video, by causing the display unit to provide the operation assistance video in part of an area in which the operation screen is provided.

This feature allows the operation assistance apparatus to simultaneously display the operation screen and the operation assistance video, so that it is easy for the assistance recipient to see the operation screen and the operation assistance video. Hence, the operation assistance apparatus can efficiently assist the assistance recipient, contributing to further reduction in mechanical and communication load.

The video reproducing unit may repeat reproducing the video data.

This feature allows the video reproducing unit to repeat reproducing the video data, and the operation assistance apparatus can cause the display unit to repeat providing the operation assistance video with the operation screen recorded. Even though the assistance recipient may not be able to carry out a desired operation, watching the operation assistance video only once, this feature allows him or her to repeatedly watch the operation assistance video to carry out the desired operation. Hence, the operation assistance apparatus can efficiently assist the assistance recipient, contributing to further reduction in mechanical and communication load.

In the case where a first operation screen is generated before the operation screen and a second operation screen is the operation screen, the video reproducing unit may read from the storage unit video data of the second operation screen as video data corresponding to the operation screen, the video data of the second operation screen being recorded when the first operation screen transits to the second operation screen.

In the case where the first operation screen transits to the second operation screen, this feature allows the operation assistance apparatus to cause the display unit to provide an operation assistance video recorded when the same transition is made. Thus, the operation assistance apparatus can enhance a possibility of displaying an operation assistance video which suits for assisting an operation that the assistance recipient desires to carry out. Hence, the operation assistance apparatus can efficiently assist the assistance recipient, contributing to further reduction in mechanical and communication load.

The operation assistance apparatus may be provided in a form of an integrated circuit.

An operation assistance method according to another aspect of the present invention involves transmitting data of an operation screen to a communications terminal so as to share the operation screen with the communications terminal. The operation screen works as a graphical user interface (GUI). The screen sharing unit is connected with the communications terminal via a network. The operation assistance method includes: generating the operation screen according to a user operation received via an input unit; recording the operation screen to generate video data, and storing the video data in a storage unit, in the case where the operation screen is shared with the communications terminal; causing a display unit to provide the operation screen; and retrieving video data corresponding to the operation screen from among the video data stored in the storage unit by the video recording unit, and reproducing the retrieved video data, in the case where the operation screen is not shared with the communications terminal, wherein in the case where the operation screen is not shared with the communications terminal, the causing the display unit involves simultaneously providing the operation screen and an operation assistance video which the reproduced video data shows.

This method can provide a similar effect as the operation assistance apparatus can.

Furthermore, the present invention can be provided as a program causing a computer to execute each of the steps included in the operation assistance method. As a matter of course, such a program may be distributed via a recording medium such as a compact disc read only memory (CD-ROM) and a transmission medium such as the Internet.

### Advantageous Effects of Invention

In the case where the operation screen is not shared with the communications terminal, the present invention can cause a display unit to automatically provide, depending on the current operation screen, an operation assistance video recorded when the operation screen was previously shared with a communications terminal. Accordingly, the present invention can effectively assist an assistance recipient. As a result, the present invention successfully avoids displaying an operation assistance video which is unrelated with the current operation screen, and reduces a mechanical load. Furthermore, the present invention can prevent the communications terminal from sharing the operation screen when video data corresponding to the current operation screen is already stored, and thus can reduce a communication load.

### BRIEF DESCRIPTION OF DRAWINGS

FIG. 1 depicts a block diagram showing a structure of an operation assistance system according to the embodiment of the present invention.

FIG. 2A shows an example of a transition of an operation screen to be provided on a display according to the embodiment of the present invention.

FIG. 2B shows an example of a transition of the operation screen to be provided on the display according to the embodiment of the present invention.

FIG. 2C shows an example of a transition of the operation screen to be provided on the display according to the embodiment of the present invention.

FIG. 2D shows an example of a transition of the operation screen to be provided on the display according to the embodiment of the present invention.

FIG. 3 shows an example of a configuration of an operation assistance video file according to the embodiment of the present invention.

FIG. 4 shows an example of a configuration of operation assistance video managing information according to the embodiment of the present invention.

FIG. 5 depicts a flowchart showing a flow of a process executed in the operation assistance apparatus according to the embodiment of the present invention.

FIG. 6 shows an example of an area in which the operation assistance video is to be displayed according to the embodiment of the present invention.

FIG. 7 shows another example of an area in which the operation assistance video is to be displayed according to the embodiment of the present invention.

FIG. 8 shows an example of an operation assistance video and operation information to be provided on the display according to the embodiment of the present invention.

FIG. 9 depicts a flowchart showing a flow of a process executed when a video according to the embodiment of the present invention is reproduced.

FIG. 10 depicts a flowchart showing a flow of a process for sharing the operation screen in the operation assistance system according to the embodiment of the present invention.

FIG. 11 shows another example of an operation assistance video and operation information to be provided on the display according to the embodiment of the present invention.

FIG. 12 depicts a block diagram showing a functional structure of the operation assistance system in Modification 1 according to the embodiment of the present invention.

FIG. 13 depicts a block diagram showing a functional structure of the operation assistance system in Modification 2 according to the embodiment of the present invention.

### DESCRIPTION OF EMBODIMENT

Described hereinafter is an embodiment of the present invention, with reference to the drawings.

### Embodiment

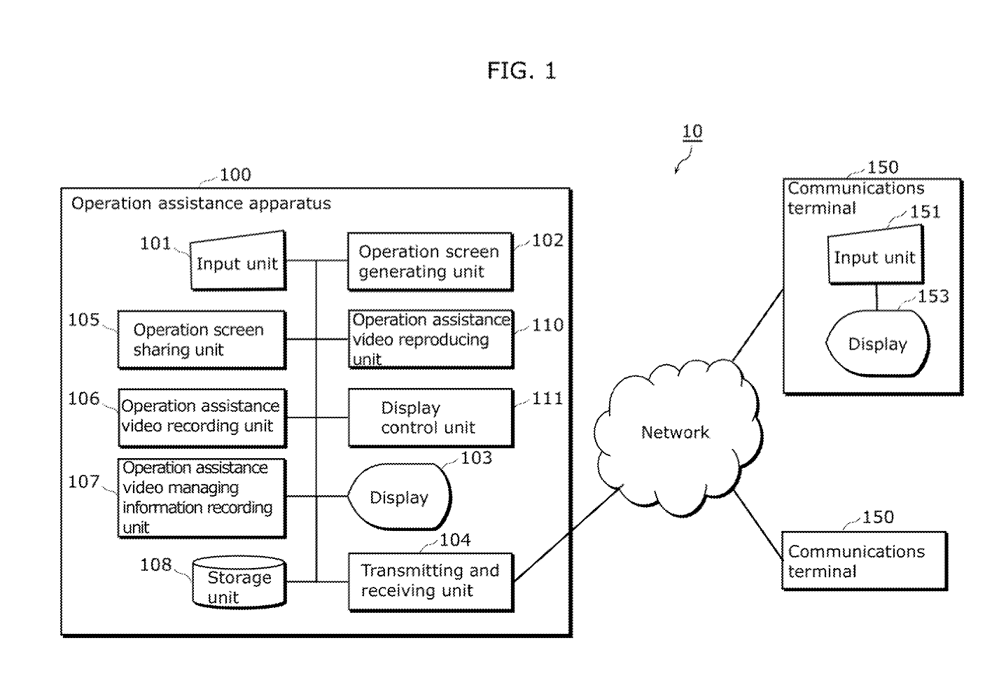

FIG. 1 depicts a block diagram showing a structure of an operation assistance system 10 according to the embodiment of the present invention. As shown in FIG. 1, the operation assistance system 10 includes an operation assistance apparatus 100 which an assistance recipient operates, and a communications terminal 150 which an assistant, who is different from the assistance recipient, operates. The operation assistance apparatus 100 and the communications terminal 150 are connected to each other via a network. In general, the operation assistance apparatus 100 and the communications terminal 150 are separately placed with each other.

Here, prospective assistance recipients include elderly users having no or few operational skills. Prospective assistants include users who are familiar with the operation of the operation assistance apparatus 100 or support engineers.

The operation assistance apparatus 100 transmits, to the communications terminal 150, the video data of an operation screen working as a GUI in order to share the operation screen with the communications terminal 150. The details of each of structural elements included in the operation assistance apparatus 100 shall be described later.

The communications terminal 150 includes an input unit 151 and a display 153. Based on the video data of the operation screen transmitted from the operation assistance apparatus 100, the communications terminal 150 causes the display 153 to provide the operation screen. Moreover, the communications terminal 150 receives the operation from the assistant via the input unit 151, and transmits, to the operation assistance apparatus 100, operation information indicating the received operation. As a result, the assistant is capable of remotely operating the operation assistance apparatus 100 via the communications terminal 150.

It is noted that both of the operation assistance apparatus 100 and the communications terminal 150 can receive an operation from the user via an input unit such as a remote controller (hereinafter simply referred to as “remote”) and a touch panel. Specifically, the operation assistance apparatus 100 and the communications terminal 150 may be, for example, a television (TV) a hard disk drive (HDD), a recorder, a home server, and a personal computer (PC).

It is noted that the remote is an input device for transmitting a signal used for remotely operating a device to be operated via radio waves such as infrared rays. In general, the remote is used where the device to be operated is found relatively near the remote. The touch panel is an input device to provide a signal indicating a location which the user touches on a touch area (hereinafter referred to as touch location).

Exemplified here is the transition of the operation screen when the operation assistance apparatus 100 receives an operation from the user.

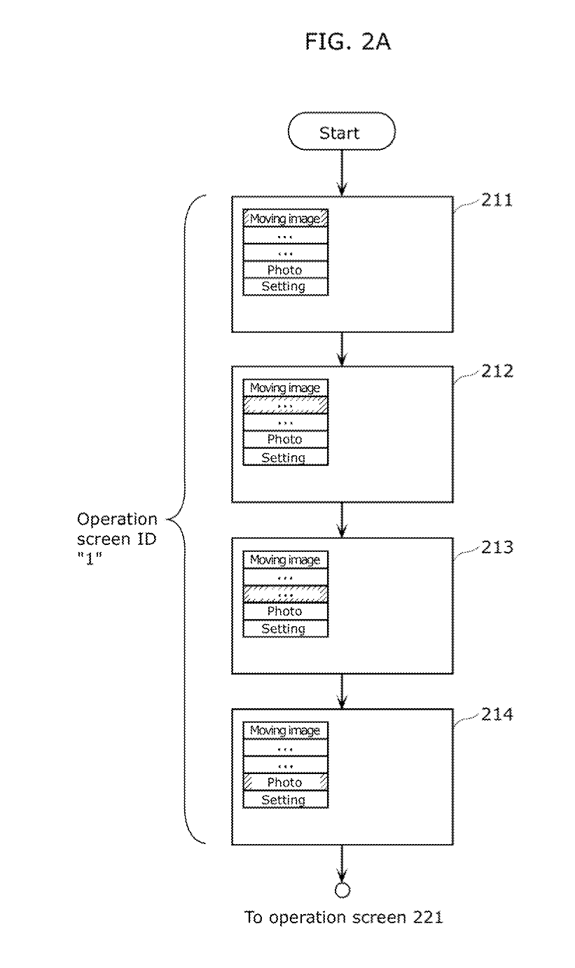

FIGS. 2A to 2D show an example of a transition of an operation screen to be provided on a display 103 according to the embodiment of the present invention. Specifically, FIGS. 2A to 2D show a transition of the operation screen when the operation assistance apparatus 100 receives from the user an operation to cause the display 103 to provide photos as a slide show (hereinafter referred to as “slide show operation”).

First, as shown in FIG. 2A, the user selects “Photo” in a menu showing a list of operations on the operation screen having an operation screen ID “1”. Next, as shown in FIG. 2B, the user selects “Event” on the operation screen having an operation screen ID “2”. “Event” shows how to classify photos to be displayed.

As shown in FIG. 2C, on the operation screen having an operation screen ID “3”, the user selects some of displayed pictures, and gives the operation assistance apparatus 100 an instruction to start the “slide show” of the selected photos. Finally, as shown in FIG. 2D, the slide show, presenting the photos selected on the operation screen having the operation screen ID “3”, is run on the operation screen having an operation screen ID “4”.

FIGS. 2A to 2D show the details of the above operation.

First, as shown in FIG. 2A, the menu showing the list of operations, including multiple operations, is activated on an operation screen 211. When a down button on the remote is pressed three times, the cursor moves down (operation screens 212 to 214). It is noted that the cursor is illustrated as a patched portion in the drawings below, and is indicating a menu item selected with the remote.

On the operation screen 214 on which a desired menu item “Photo” is selected, the user presses an enter button. Then, the operation screen 214 having the operation screen ID “1” transits to the operation screen 221 having the operation screen ID “2” in FIG. 2B.

Next, on the operation screen 221 after the transition, the user presses a right button. Then, the cursor moves right (the operation screen 222). Furthermore, the user presses a down button in the operation screen 222 to move the cursor down (the operation screen 223).

When the user presses the enter button in the operation screen 223 on which the desired menu item “Event” is selected, the operation screen 223 having the operation screen ID “2” transits to the operation screen 231 having the operation screen ID “3” in FIG. 2C.

Next, on the operation screen 231 after transition, the user carries out a selection operation for selecting photos to be used in the slide show in order to select the photos (the operation screen 232). When the user presses a sub-menu button on the operation screen 232, a menu is displayed for starting the slide show (the operation screen 233). In the operation screen 233, the user presses the down button to move the cursor to “Slide show” (the operation screen 234).

When the user presses the enter button on the operation screen 234, the slide show starts. In other words, the operation screen 234 having the operation screen ID “3” transits to the operation screen 241 having the operation screen ID “4” in FIG. 2D. The operation screen 241 appears when the slide show is being run. As shown in the operation screen 242, for example, the slide show may provide an effect of zooming in on a face.

The case described hereinafter is on the presumption that an assistance recipient operating the operation assistance apparatus 100 is asking an assistant for an operation assistance for a “slide show operation” illustrated in FIGS. 2A to 2D.

Described next is each of the structural elements included in the operation assistance apparatus 100, with reference to FIG. 1 again.

As shown in FIG. 1, the operation assistance apparatus 100 includes an input unit 101, an operation screen generating unit 102, the display 103, a transmitting and receiving unit 104, an operation screen sharing unit 105, an operation assistance video recording unit 106, an operation assistance video managing information recording unit 107, a storage unit 108, an operation assistance video reproducing unit 110, and a display control unit 111.

The input unit 101 receives from the assistance recipient an operation directed to the operation screen provided on the display 103. For example, the input unit 101 is a touch panel, and provides, as touch information, information indicating a touch location on a touch area of the touch panel.

Furthermore, for example, the input unit 101 may be a remote having multiple operation keys. Here, for example, the input unit 101 provides, as the operation information, information for specifying an operation key which the user operates among the operation keys.

It is noted that the input unit 101 does not necessarily have to be a touch panel or a remote; instead, the input unit 101 may be, for example, a keyboard or a mouse.

The operation screen generating unit 102 is equivalent to a screen generating unit. The operation screen generating unit 102 generates an operation screen based on the user operation received via the input units 101 and 151.

Specifically, the operation screen generating unit 102 generates or updates the operation screen based on the operation information provided from the input unit 101. The generated or updated operation screen is provided on the display 103 by the display control unit 111.

Moreover, the operation screen generating unit 102 generates or updates the operation screen based on the operation information received from the communications terminal 150 via the transmitting and receiving unit 104 and the operation screen sharing unit 105. As a result, the operation assistance apparatus 100 is remotely controlled by the assistant via the communications terminal 150.

It is noted that generating an operation screen means generating an operation screen having an operation screen ID (the operation screens 211 and 221, for example) which is different from the operation screen ID of the operation screen generated immediately before. Furthermore, updating an operation screen means updating an operation screen which has already been provided on the display 103 (the operation screens 212 and 222, for example).

The display 103 is equivalent to a display unit. The display 103 may be, for example, a liquid crystal display or a plasma display. Controlled by the display control unit 111, the display 103 displays an operation screen and an operation assistance video.

The transmitting and receiving unit 104 is a communications interface for communicating with the communications terminal 150 connected via a network.

The operation screen sharing unit 105 transmits the data of the operation screen to the communications terminal 150 to share the operation screen with the communications terminal 150. Specifically, the operation screen sharing unit 105 transmits, to the communications terminal 150 via the transmitting and receiving unit 104, the data of the operation screen generated by the operation screen generating unit 102 (the data indicating a difference between the data of the operation screen generated by the operation screen generating unit 102 and the video data of the operation screen already transmitted to the communications terminal 150). As a result, the operation screen provided on the display 103 of the operation assistance apparatus 100 is also provided on the display 153 of the communications terminal 150.

Furthermore, the operation screen sharing unit 105 receives, via the transmitting and receiving unit 104, the operation information showing the details of the operation carried out by the assistant to the communications terminal 150, and outputs the operation information to the operation screen generating unit 102.

It is noted that, when the operation assistance apparatus 100 starts to share the operation screen with the communications terminal 150, the assistance recipient, for example, makes a contact with the assistant on the phone. Then, the contacted assistant connects the communications terminal 150 to the network, activates the operation screen sharing function of the communications terminal 150, and establishes a connection with the operation assistance apparatus 100. In the case where the communications terminal 150 is connected to the network and the operation assistance apparatus 100 has the address of the communications terminal 150, the operation assistance apparatus 100 can also transmit to the communications terminal 150 a request to start sharing the operation screen via the network.

The operation assistance video recording unit 106 is equivalent to an image recording unit. In the case where the operation screen sharing unit 105 shares the operation screen with the communications terminal 150, the operation assistance video recording unit 106 records the operation screen to generate video data. Furthermore, the operation assistance video recording unit 106 stores the generated video data in the storage unit 108.

Specifically, when the operation screen is shared with the communications terminal 150, the operation assistance video recording unit 106 records the operation screen generated by the operation screen generating unit 102 to generate the video data. Moreover, the operation assistance video recording unit 106 stores the generated video data in the storage unit 108 as an operation assistance video file 300.

The operation assistance video managing information recording unit 107 is equivalent to an operation information recording unit. The operation assistance video managing information recording unit 107 stores the operation information in the storage unit 108 in association with the video data. Here, the operation information shows the details of the operation carried out to the operation screen. Specifically, when the operation screen is recorded, the operation assistance video managing information recording unit 107 generates and records operation assistance video managing information 400 including the operation information as management information on each of operation assistance video files 300.

The storage unit 108 may be, for example, an HDD or a Solid State Drive (SSD). The storage unit 108 is used for storing the operation assistance video files 300 and the operation assistance video managing information 400.

The operation assistance video reproducing unit 110 is equivalent to a video reproducing unit. In the case where the operation screen is not shared with the communications terminal 150, the operation assistance video reproducing unit 110 retrieves video data corresponding to the generated operation screen from among the video data stored in the storage unit 108 by the operation assistance video recording unit 106. Furthermore, the operation assistance video reproducing unit 110 reproduces the retrieved video data, and provides the reproduced video data to the display control unit 111. Moreover, the operation assistance video reproducing unit 110 reads from the storage unit 108 the operation information corresponding to the retrieved video data, and provides the read operation information to the display control unit 111.

In the case where the operation screen is shared with the communications terminal 150, the display control unit 111 causes the display 103 to provide the operation screen thereon. In the case where the operation screen is not shared with the communications terminal 150, the display control unit 111 causes the display 103 to simultaneously provide thereon both the operation screen and the operation assistance video which the reproduced video data shows.

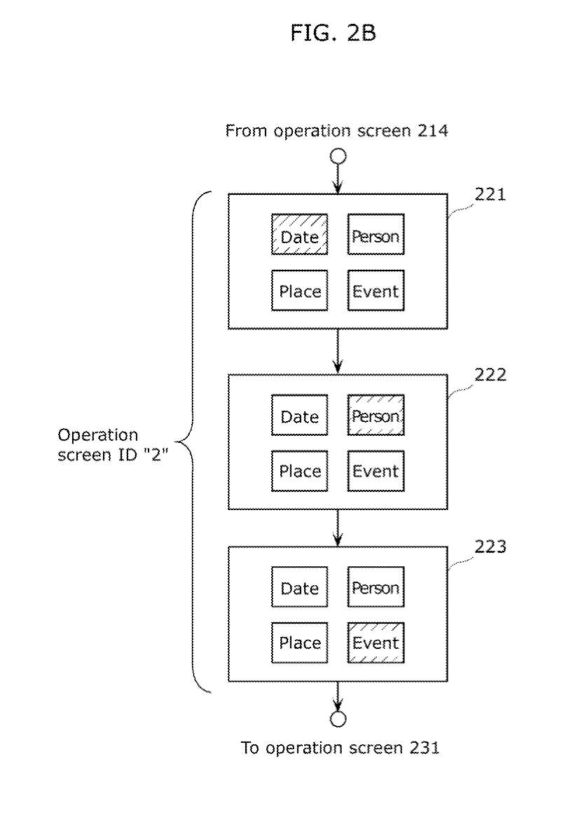

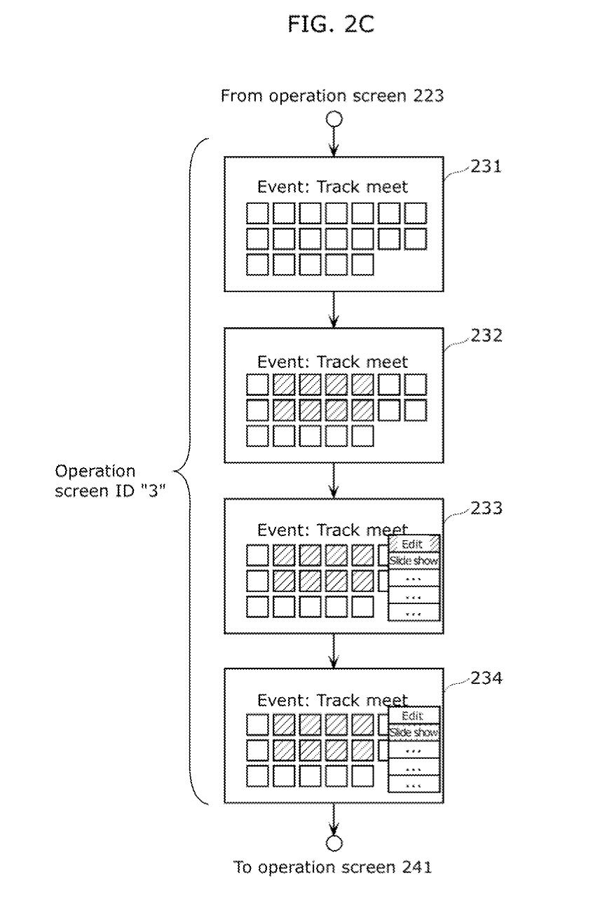

Detailed next are the operation assistance video files 300 and the operation assistance video managing information 400 that are held in the storage unit 108, with reference to FIGS. 3 and 4.

FIG. 3 shows an example of a configuration of the operation assistance video file 300 operation assistance video file according to the embodiment of the present invention. The operation assistance video file 300 has a header region 301 at the beginning thereof, followed by a data region 302.

The header region 301 holds associated data including version information indicating the version of the operation assistance video file 300 and identification information (an operation assistance video ID) used for uniquely identifying the operation assistance video file 300. The data region 302 holds the video data generated when the operation screen is recorded. It is noted that the data region 302 may further hold additional data such as music data.

The data region 302 in FIG. 3 holds the video data in which the operation screen when the “slide show operation” in FIGS. 2A to 2D is carried out is recorded. The record format of the video data may be either a common format or a unique format. For example, the recording format may be MPEG-2 and the H. 264.

FIG. 4 shows an example of a configuration of operation assistance video managing information 400 according to the embodiment of the present invention. As shown in FIG. 4, the operation assistance video managing information 400 includes an operation assistance video ID 401, an assistant's name 402, an operation assistance title 403, operation screen switching position information 404, and operation assistance information 408.

The operation assistance video ID 401 is identification information for uniquely identifying the operation assistance video file 300. The operation assistance video ID 401 associates the operation assistance video file 300 with the operation assistance video managing information 400.

The assistant's name 402 is the name of the assistant who provides the operation assistance on the communications terminal 150.

The operation assistance title 403 is information on the details of the operation assistance. For example, the operation assistance title 403 is a title such as “Play slide show” and “Programmed recording”. It is noted that the operation assistance title 403 is automatically determined by the operation assistance apparatus 100 based on the transition of the operation screen. The operation assistance title 403 may also be entered by the assistant provider or by the assistant recipient.

The operation screen switching position information 404 indicates a temporal position of the video data in which the operation screen is recorded. When an operation screen having an operation screen ID transits to another operation screen having another operation screen ID which is different from the operation screen ID, the operation screen switching position information 404 is determined based on the information notified by the operation screen generating unit 102. As shown in FIG. 4, specifically, the operation screen switching position information 404 includes at least one combination of an operation screen ID 405, a time stamp information 406, and a video location information 407.

The operation screen ID 405 is identification information for identifying the operation screen.

The time stamp information 406 indicates a time period in which the operation screen of the operation screen ID 405 is recorded. Specifically, the time stamp information 406 indicates a time period from the start of recording the operation screen of the operation screen ID 405 until the operation screen switches to another operation screen having the next operation screen ID (18:20:30 to 18:21:15).

The video location information 407 indicates where in the operation assistance video file 300 the video data in which the operation screen of the operation screen ID 405 is stored (for example: offset 128 kilobytes and size 512 kilobytes).

The combination of the operation screen ID 405, the time stamp information 406, and the video location information 407 is newly added to the operation screen switching position information 404 each time the operation screen switches to a different operation screen ID.

The operation assistance information 408 includes (i) time stamp information 409 indicating the timing with which the assistant carried out the operation to the operation screen and (ii) operation information 410 indicating the details of the operation. Specifically, the time stamp information 409 indicates the time at which the assistant carries out the operation to the operation screen, using the remote or the touch panel (for example, 18:20:45). Furthermore, the operation information 410 is provided at the time that the time stamp information 409 indicates, and includes information for specifying which operation key is operated and coordinate position information indicating where on the touch panel the touch location is.

Described next are the operations of the above-structured operation assistance apparatus 100.

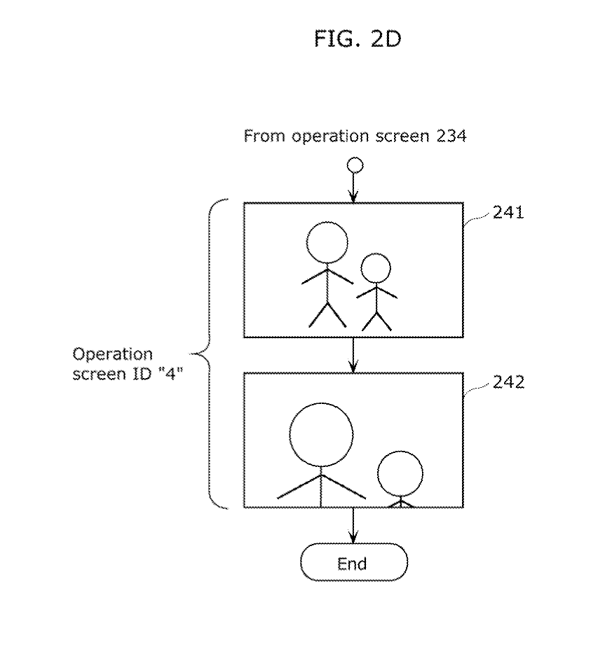

FIG. 5 depicts a flowchart showing a flow of a process executed in the operation assistance apparatus 100 according to the embodiment of the present invention.

First, the operation screen generating unit 102 generates an operation screen based on the user operation received via the input units 101 and 151 (S101). For example, when the operation screen is shared with the communications terminal 150, the operation screen generating unit 102 generates the operation screen according to the operation (the operation information received from the communications terminal 150 via the transmitting and receiving unit 104) of the assistant received via the input unit 151. When the operation screen is not shared with the communications terminal 150, for example, the operation screen generating unit 102 generates the operation screen according to the operation of the assistance recipient received via the input unit 101.

Next, the operation screen sharing unit 105 determines whether or not the generated operation screen is shared with the communications terminal 150 (S102). For example, depending on whether or not the data of the generated operation screen is to be transmitted to the communications terminal 150, the operation screen sharing unit 105 determines whether or not the operation screen is shared with the communications terminal 150.

In the case where the operation screen is shared (S102: Yes), the operation assistance video recording unit 106 records the operation screen to generate video data. Moreover, in the storage unit 108, the operation assistance video recording unit 106 holds the operation assistance video file 300 including the generated video data and the operation assistance video managing information 400 including the operation information (S103). Then, the display control unit 111 causes the display 103 to provide the operation screen (S104), and the process returns to Step S101.

In contrast, in the case where the operation screen is not shared (S102: No), the operation assistance video reproducing unit 110 reproduces video data which is stored in the storage unit 108 and corresponds to the operation screen (S105).

Specifically, from among the operation assistance video files 300 previously stored in the storage unit 108 by the operation assistance video recording unit 106, the operation assistance video reproducing unit 110 retrieves an operation assistance video file 300 including the video data corresponding to the generated operation screen, and reads the retrieved operation assistance video file 300. Furthermore, the operation assistance video reproducing unit 110 reads from the storage unit 108 the operation assistance video managing information 400 corresponding to the retrieved operation assistance video file 300. Then, the operation assistance video reproducing unit 110 reproduces the video data included in the read operation assistance video file 300 and corresponding to the generated operation screen.

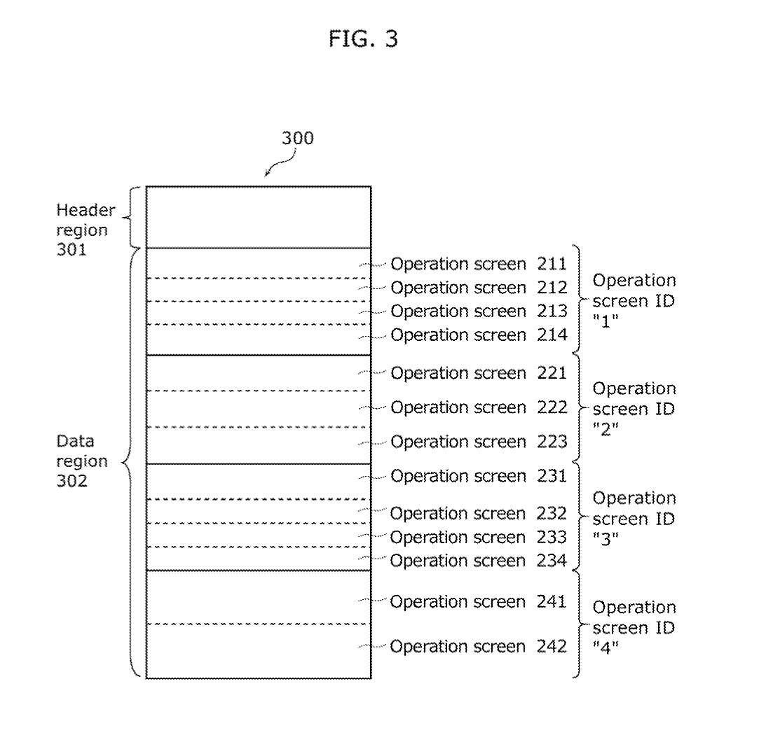

Next, the display control unit 111 causes the display 103 to simultaneously provide the generated operation screen, the operation assistance video indicated by the reproduced video data, and the operation information included in the read operation assistance video managing information 400 (S106). Then, the process returns to Step S101. Specifically, as shown in FIGS. 6 to 8 for example, the display control unit 111 causes the display 103 to provide the operation screen, the operation assistance video, and the operation information.

FIG. 6 shows an example of an area in which the operation assistance video is to be displayed according to the embodiment of the present invention. In FIG. 6, the operation assistance video is displayed on an auxiliary screen 502 provided in an area within an operation screen 501.

In other words, the display control unit 111 causes the display 103 to simultaneously provide the operation screen and the operation assistance video by causing the display 103 to provide the operation assistance video so that the operation assistance video overlaps part of the area in which the operation screen is displayed. This allows the operation assistance apparatus 100 to cause the display 103 to simultaneously provide the operation screen and the operation assistance video. Thus, it is easy for the assistance recipient to see the operation screen and the operation assistance video.

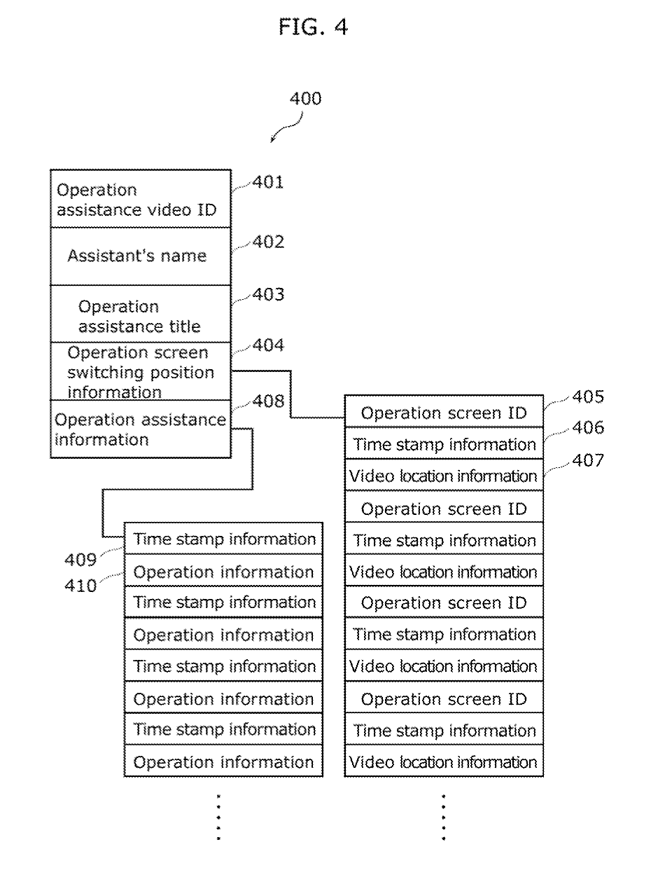

It is noted that in the case where multiple pieces of the video data are read in Step S105, the display control unit 111 may cause the display 103 to provide multiple operation assistance videos as shown in FIG. 7.

FIG. 7 shows another example of an area in which the operation assistance video is to be displayed according to the embodiment of the present invention. As shown in FIG. 7, the display control unit 111 may display the operation assistance video on multiple auxiliary screens; namely, the auxiliary screen 502 and an auxiliary screen 503, instead of one auxiliary screen. In other word, in the case where multiple pieces of video data are retrieved, the display control unit 111 may cause the display 103 to simultaneously provide the operation screen and operation assistance videos shown by the pieces of video data that are reproduced.

Thus, when multiple operations can be carried out to the operation screen, this feature allows the operation assistance apparatus 100 to cause the display 103 to simultaneously provide multiple operation assistance videos recorded when the operations, that are different from each other, are carried out. Hence, the operation assistance apparatus 100 can efficiently assist the assistance recipient in a short time.

In the case where pieces of video data are read in Step S105, the display control unit 111 may cause the display 103 to simultaneously provide the operation screen and the operation assistance videos shown by the pieces of video data to be reproduced, so that the operation assistance videos are sequentially provided. Thus, when multiple operations can be carried out to the operation screen, this feature allows the operation assistance apparatus 100 to cause the display 103 to sequentially provide multiple operation assistance videos recorded when the operations, that are different from each other, are carried out. Hence, the operation assistance apparatus 100 can display multiple operation assistance videos without significantly reducing an area in which the operation screen is to be displayed. Accordingly, the operation assistance apparatus 100 can efficiently assist the assistance recipient.

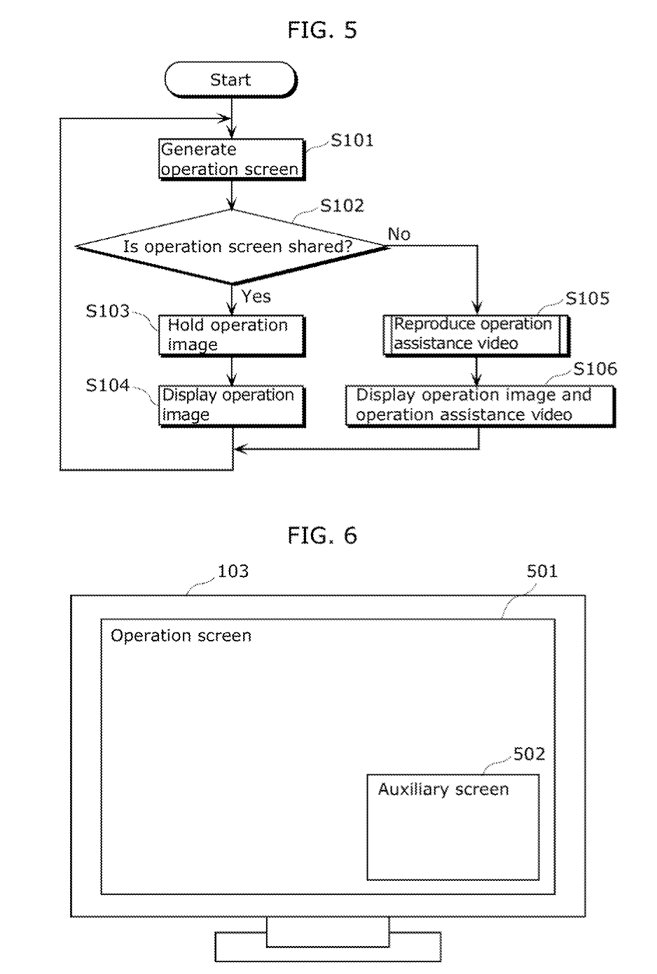

FIG. 8 shows an example of an operation assistance video and operation information to be provided on the display 103 according to the embodiment of the present invention. In FIG. 8, the auxiliary screen 502 displays the operation assistance video recorded when the assistant operates the operation assistance apparatus 100 via the communications terminal 150.

Moreover, the auxiliary screen 502 provides an operation images 701 and 702, and an operation text message 703 based on the operation assistance information 408 included in the operation assistance video managing information 400. Described here is the case where the operation assistance information 408 includes operation information indicating the touch location on the touch area of the touch panel, and operation information indicating the name of an assistant and the title of an operation.

The operation image 701 is an area in which the operation assistance video is displayed. The operation image 701 is an image of a hand overlapping, to be displayed, an area corresponding to the touch location which the operation information indicates. The operation image 701 is displayed so that the time at which the touch location is detected and the time the operation screen is recorded are synchronized with each other.

It is noted that the operation image 701 does not necessarily have to be an image of a hand; instead, the operation image 701 may be any image that can indicate the touch location. For example, the operation image 701 may be the image of an arrow.

The operation image 702 is an image of an arrow overlapping, to be displayed, the operation assistance video based on the touch location that the operation information indicates. The operation image 702 shows a temporal change of the touch location. In other words, the display control unit 111 causes the display 103 to provide the operation image 702 showing the temporal change of the touch location.

The operation text message 703 shows the name of the assistant and the title of an operation when the operation assistance video is recorded.

Thus, when causing the display 103 to provide the operation assistance video, the display control unit 111 also causes the display 103 to simultaneously provide the operation information read by the operation assistance video reproducing unit 110. Hence, the operation assistance apparatus 100 can efficiently assist the assistance recipient.

Moreover, the operation assistance apparatus 100 can cause the display 103 to provide information of the touch location on the touch panel. Hence, the operation assistance apparatus 100 can assist the assistance recipient efficiently.

Furthermore, the display control unit 111 causes the display 103 to provide the operation image 701 so that the time when the operation information is provided and the time when the operation screen is recorded synchronize with each other. Furthermore, the display control unit 111 causes the display 103 to provide the operation information by having the operation image 701 overlap an area found in the operation assistance video and corresponding to the touch location indicated with the operation information.

As a result, the operation assistance apparatus 100 can virtually replicate an operation which the assistant has carried out to the touch panel. Accordingly, the operation assistance apparatus 100 can efficiently assist the operation carried out by the assistance recipient and directed to the operation screen. In other words, the assistance recipient can carry out a desired operation by moving his or her hand, following the move of the hand displayed in the operation assistance video.

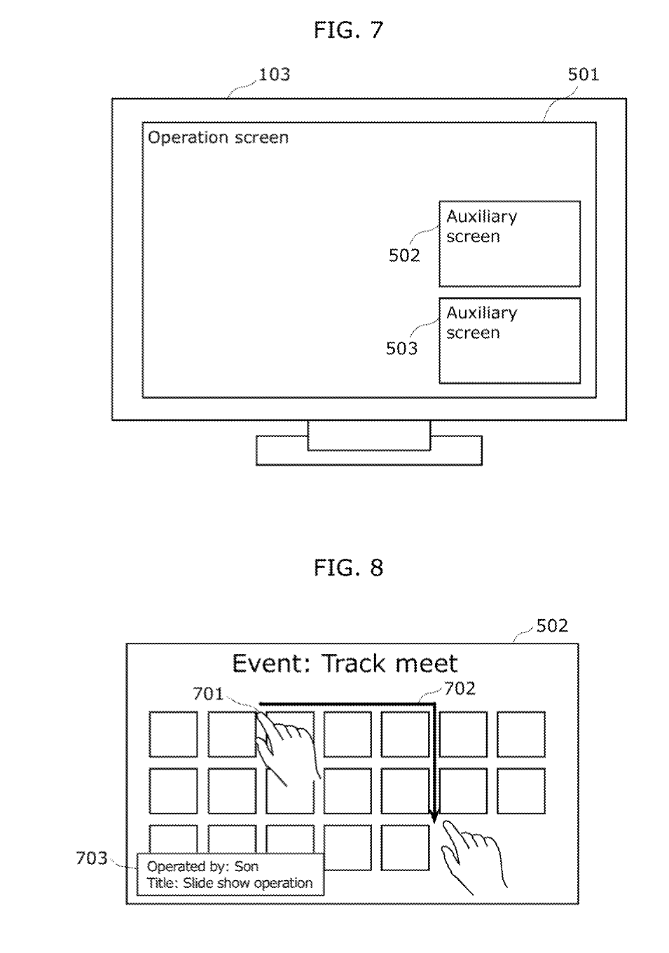

Detailed next is a process for reproducing the video data with reference to the flowchart in FIG. 9.

FIG. 9 depicts a flowchart showing a flow of a process (S105) executed when a video according to the embodiment of the present invention is reproduced.

The moment the operation screen ID of an operation screen changes, the operation screen generating unit 102 notifies the operation assistance video reproducing unit 110 of the current operation screen ID (hereinafter referred to as “first operation screen ID”) and the following operation screen ID (hereinafter referred to as “second operation screen ID”). In other words, the operation assistance video reproducing unit 110 receives the first and the second operation screen IDs from the operation screen generating unit 102 (S201).

Next, from among the operation assistance video files 300 stored in the storage unit 108, the operation assistance video reproducing unit 110 retrieves an operation assistance video file 300 including the video data in which the operation screen having the second operation screen ID is recorded (S202). Specifically, the operation assistance video reproducing unit 110 matches the second operation screen ID that is notified of with the operation screen ID 405 included in the operation assistance video managing information 400 in order to retrieve the operation assistance video file 300.

In the case where there is no operation assistance video file 300 including the operation screen ID 405 that matches the second operation screen ID (S203: No), the process ends.

In the case where there is an operation assistance video file 300 including the operation screen ID 405 that matches the second operation screen ID (S203: Yes), the operation assistance video reproducing unit 110 reads the operation assistance video file 300 from the storage unit 108 (S204).

Next, the operation assistance video reproducing unit 110 reproduces the video data corresponding to the second operation screen ID among video data included in the read operation assistance video file 300 (S205).

Specifically, with reference to the operation assistance video managing information 400 stored in the storage unit 108, the operation assistance video reproducing unit 110 obtains video location information 407 of the operation screen ID 405 that match the second operation screen ID. Then, based on the obtained video location information 407, the operation assistance video reproducing unit 110 automatically reproduces the video data corresponding to the second operation screen ID among video data included in the operation assistance video file 300.

Hence, the operation assistance video reproducing unit 110 reads the video data corresponding to the generated operation screen, and reproduces the read video data.

It is noted that the operation assistance video reproducing unit 110 preferably repeats reproducing the video data until the operation screen is generated again in the Step S101. In other words, the operation assistance video reproducing unit 110 preferably repeats reproducing the operation assistance video until the operation screen generating unit 102 notifies the operation assistance video reproducing unit 110 of the next operation screen ID; that is, until an operation screen on which the user is operating transits to another operation screen.

Even though the assistance recipient may not be able to carry out a desired operation, watching the operation assistance video only once, this feature allows him or her to repeatedly watch the operation assistance video to carry out the desired operation. In other words, the operation assistance apparatus 100 is significantly assistance recipient friendly.

It is noted that, when repeatedly reproducing the operation assistance video, the operation assistance video reproducing unit 110 may end the reproduction once the operation assistance video has been reproduced for a predetermined times. This feature allows the operation assistance video reproducing unit 110 to avoid unnecessarily repeating the reproduction of an undesired operation assistance video for the assistance recipient.

Moreover, in Step S202, the operation assistance video reproducing unit 110 retrieves the operation assistance video file 300 based only on the second operation screen ID; instead, the operation assistance video reproducing unit 110 may retrieve the operation assistance video file 300 based on the first operation screen ID.

Specifically, the operation assistance video reproducing unit 110 may retrieve the operation assistance video file 300 including the video data of the operation screen having the second operation screen ID. Here, the operation screen having the second operation screen ID is recorded when the operation screen having the first operation screen ID transits to the operation screen having the second operation screen ID. In other words, the operation assistance video reproducing unit 110 may read from the storage unit 108 the video data of the second operation screen as video data corresponding to the generated operation screen. Here, the video data of the second operation screen is recorded when the operation screen having the first operation screen ID transits to the operation screen having the second operation screen ID.

In the case where the first operation screen transits to the second operation screen, this feature allows the operation assistance apparatus 100 to cause the display 103 to provide an operation assistance video recorded when the same transition is made. Thus, the operation assistance apparatus 100 can enhance the possibility of displaying an operation assistance video which suits for assisting an operation that the assistance recipient desires to carry out. In other words, the operation assistance apparatus 100 can efficiently assist the assistance recipient.

Detailed next is a process to share an operation screen.

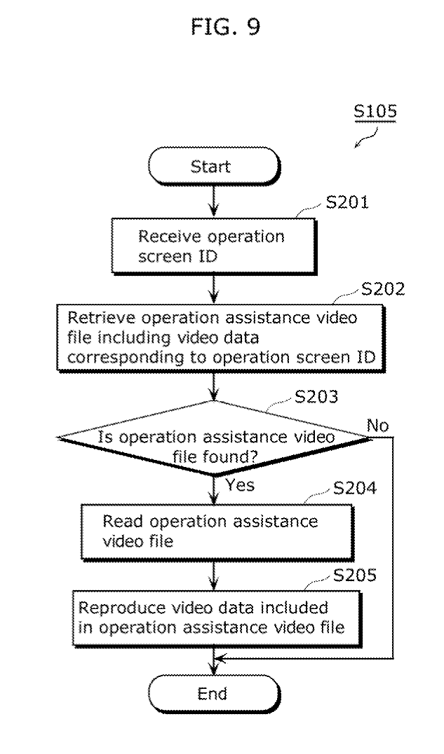

FIG. 10 depicts a flowchart showing the flow of the process for sharing the operation screen in an operation assistance system according to the embodiment of the present invention. FIG. 10 shows the flow of the process in the operation assistance apparatus 100 on the right, and the flow of the process in the communications terminal 150 on the left. As a presumption of the flowchart in FIG. 10, the operation assistance apparatus 100 and the communications terminal 150 are running.

First, according to the operation of an assistance recipient, the operation assistance apparatus 100 causes the display 103 to provide an operation screen to start sharing the operation screen (S301). Then, the operation assistance apparatus 100 starts a request menu for requesting the communications terminal to share the operation screen (S302). It is noted that the details of the request menu for requesting the communications terminal to share the operation screen shall be omitted.

Then, on the request menu for requesting the communications terminal to share the operation screen, the operation assistance apparatus 100 receives from the assistance recipient an operation for selecting the communications terminal 150 which the operation assistance apparatus 100 requests to share the operation screen (S303). Then, the operation assistance apparatus 100 transmits to the selected communications terminal 150 a request for sharing the operation screen (hereinafter referred to as “sharing request”) (S304).

Next, the communications terminal 150 receives the sharing request transmitted from the operation assistance apparatus 100 (S401). Then, the communications terminal 150 receives an answer to the sharing request from an assistant, and transmits the received answer (S402). Specifically, for example, the communications terminal 150 provides on the display 153 a message and an agreement check regarding the sharing request such that the message and the agreement pop up. Then, the communications terminal 150 receives from the assistant the answer indicating whether or not the assistant agrees the operation assistance request.

The operation assistance apparatus 100 receives the answer to the sharing request via the transmitting and receiving unit 104 (S305). Here, in the case where the received answer is “denied” (S306: No), the screen of the display 103 returns to the operation screen. In contrast, in the case where the received answer is “agreed” (S306: Yes), the operation screen sharing unit 105 automatically transmits the video data of the operation screen generated by the operation screen generating unit 102 (S307).

The communications terminal 150 receives the video data of the operation screen, and provides the video data on the display 153 (S403). This starts the sharing of the operation screen.

The communications terminal 150 receives the operation of the assistant directed to the operation screen via the input unit 151, and transmits, to the operation assistance apparatus 100, operation information indicating the received operation (S404).

The operation assistance apparatus 100 receives the operation information from the communications terminal 150 (S308). Based on the received operation information, the operation screen generating unit 102 generates or updates the operation screen (S309). It is noted that the generated or updated operation screen is provided on the display 103 by the display control unit 111.

Furthermore, the operation assistance video recording unit 106 records the generated or updated operation screen to generate video data, and stores the video data in the storage unit 108 as the operation assistance video file 300 (S310). The process Steps S309 through S310 corresponds to the process Steps S101 through S104 shown in FIG. 5.

In the case where the communications terminal 150 does not receive from the assistant a disconnection request indicating the end of sharing the operation screen (S405: No), the process returns to Step S403 for receiving the video data of the operation screen. The operation screen continues to be shared. In contrast, in the case where the communications terminal 150 receives from assistant the disconnection request indicating the end of sharing the operation screen (S405: Yes), the communications terminal 150 transmits the disconnection request to the operation assistance apparatus 100 (S406).

Furthermore, in the case where the operation assistance apparatus 100 does not receive the disconnection request from the communications terminal 150 (S11: No), the process returns to Steps S307 for transmitting the operation screen. The operation screen continues to be shared. In contrast, in the case where the operation assistance apparatus 100 receives the disconnection request from the communications terminal 150 (S311: Yes), the operation assistance apparatus 100 disconnects itself from the communications terminal 150. The sharing of the operation screen ends (S312).

As described above, the operation assistance apparatus 100 and the communications terminal 150 share the operation screen with each other.

In the case where the operation screen is not shared with the communications terminal, the operation assistance apparatus 100 according to the embodiment can automatically causes the display 103 to provide, based on the current operation screen, the operation assistance video recorded when the operation screen was previously shared with the communications terminal. Accordingly, the operation assistance apparatus 100 is capable of efficiently assisting the assistance recipient, as well as is significantly assistance recipient friendly. As a result, the operation assistance apparatus 100 successfully avoids displaying an operation assistance video which is unrelated with the current operation screen, and reduces a mechanical load. Furthermore, the operation assistance apparatus 100 can prevent the communications terminal from sharing the operation screen when video data corresponding to the current operation screen is already stored in order to reduce a communication load.

In other words, once the assistant offers assistance in an operation, a previous operation assistance video, which holds the same operation screen as the current operation screen on which the assistance recipient is operating on, is simultaneously displayed with the current operation screen. Thus, even an assistance recipient who is not familiar with the operation can carry out a desired function, watching the operation assistance video.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

In the embodiment, for example, FIG. 8 shows the case in detail that the input unit 101 is a touch panel; however, the input unit 101 does not necessarily have to be a touch panel. For example, the input unit 101 may be a remote having multiple operation keys. Here, for example, the input unit 101 provides information for specifying an operation key which the user operates among the operation keys as the operation information. Since this feature allows the operation assistance apparatus 100 to cause the display 103 to provide information for specifying the operation key, the operation assistance apparatus 100 can effectively assist the assistance recipient when the user operates the operation screen via the remote.

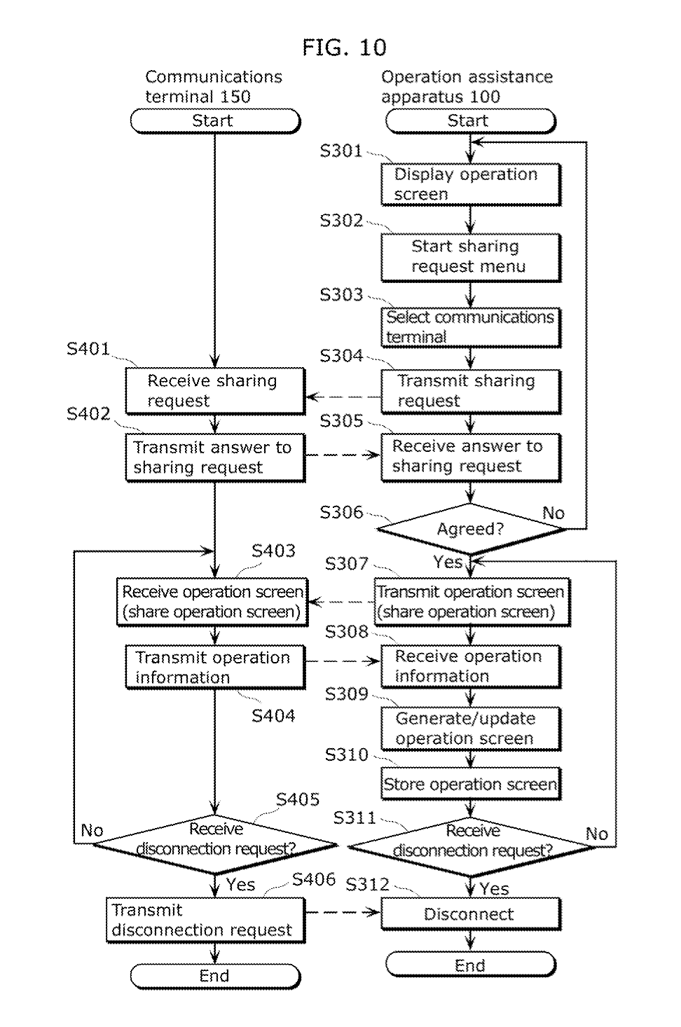

Moreover, when the input unit 101 is a remote the display control unit 111 preferably causes the display 103 to provide an operation image showing operation keys specified by the operation information, so that the time when the operation information is outputted and the time when the operation screen is recorded synchronize with each other. Specifically, as shown in FIG. 11, the display control unit 111 preferably causes the display 103 to provide an operation image 704 indicating the operation keys specified by the operation information, such that the operation image 704 synchronizes with the operation assistance video. Thus, by sequentially operating the operation keys that the operation image shows, the assistance recipient can carry out an operation for a desired function. In other words, the operation assistance apparatus 100 can efficiently assist the assistance recipient.

Moreover, the operation assistance video reproducing unit 110 may change the reproduction status of video data according to an operation which the input unit 101 receives. Here, the input unit 101 receives from the assistance recipient an operation for changing an operation assistance video reproduction status provided on the display 103. Specifically, the input unit 101 receives an operation directing the change of a reproduction status, such as pause, fast forward, rewind, and stop. Then, according to the operation that the input unit 101 receives, the operation assistance video reproducing unit 110 changes the reproduction status of the operation assistance video to pause, fast forward, rewind, and stop the reproduction of the operation assistance video.

This feature allows the assistance recipient to change the reproduction status of the operation assistance video. Accordingly, the operation assistance apparatus 100 is capable of efficiently assisting the assistance recipient, as well as is significantly assistance recipient friendly.

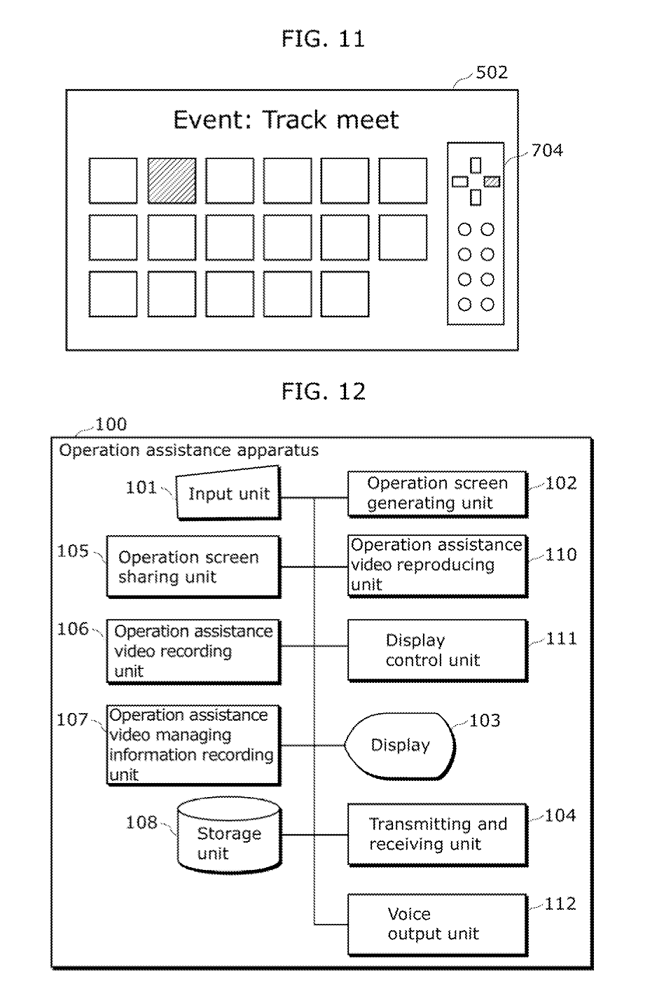

Moreover, in the embodiment, the operation information is provided on the display 103; however, the operation information does not necessarily have to be visually displayed. In other words, the operation information may be provided in voice. Here, the operation assistance apparatus 100 is structured, for example, as shown in FIG. 12.

FIG. 12 depicts a block diagram showing a functional structure of the operation assistance apparatus 100 in Modification 1 according to the embodiment of the present invention. As shown in FIG. 12, the operation assistance apparatus 100 in Modification 1 further includes a voice output unit 112 in addition to each of the structural elements that the operation assistance apparatus according to the embodiment has.

When the operation assistance video is provided on the display 103, the voice output unit 112 outputs an operating voice based on operation information read by the operation assistance video reproducing unit 110. For example, the audio output unit 112 outputs information for specifying an operation key of a remote as the operating voice.

Even though the assistance recipient takes his or her eyes from the operation assistance video provided on the display 103, this feature allows the assistance recipient to carry out an operation for a desired function by following the operating voice. Accordingly, the operation assistance apparatus 100 is capable of efficiently assisting the assistance recipient, as well as is significantly assistance recipient friendly.

In the embodiment, the operation assistance apparatus 100 displays an operation assistance video in the case where the operation screen is not shared with the communications terminal 150; however, the operation assistance apparatus 100 does not necessarily have to display the operation assistance video when the operation screen is not shared with the communications terminal 150. For example, the operation assistance apparatus 100 may display the operation assistance video only in the case where the setting for displaying the operation assistance video (hereinafter referred to as “operation assistance setting”) is enabled. Here, for example, the assistance recipient enables the operation assistance setting of the operation assistance apparatus 100 via the input unit 101. Moreover, for example, the operation assistance setting may manually be disabled by the assistance recipient or may automatically be disabled when the operation assistance apparatus 100 turns off.

In the embodiment, when the operation screen is shared, the communications terminal 150 transmits operation information to the operation assistance apparatus 100 so that the assistant can carry out an operation to the operation screen via the communications terminal 150; however, such an operation does not necessarily have to be carried out. In other words, when the operation screen is shared between the communications terminal 150 and the operation assistance apparatus 100, the communications terminal 150 may simply provide the operation screen on the display 153. In this case, the assistant may, for example, conduct voice communication, such as communication by phone to carry out operation assistance for the assistance recipient. In such a case, the operation screen is recorded when the operation screen is shared. Thus, the operation assistance apparatus 100 can assist the assistance recipient.

In the embodiment, an auxiliary screen is provided for displaying an operation assistance video, overlapping part of an area in which an operation screen is to be displayed; however, the auxiliary image does not necessarily have to overlap the operation screen. For example, on a single screen, the auxiliary screen may be provided separately from the operation screen.

In the above embodiment, the operation assistance video recording unit 106 holds video data in which operation screens having multiple operation screen IDs in the storage unit 108 are recorded as a single operation assistance video file 300; however, the video data does not necessarily have to be held in the storage unit 108 in such a manner. For example, the operation assistance video recording unit 106 may hold a separate operation assistance video file 300 for each operation screen ID.

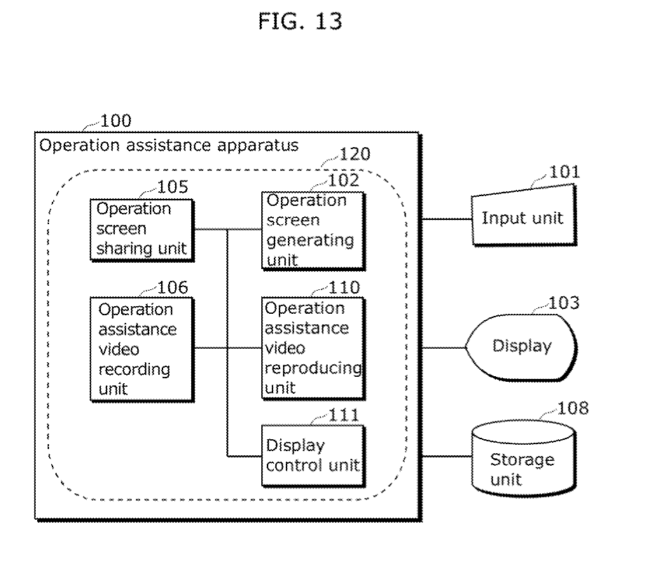

In the above embodiment, the operation assistance apparatus 100 includes each of the structural elements shown in FIG. 1; however, the operation assistance apparatus 100 does not necessarily have to include all of the structural elements in FIG. 1. As shown in FIG. 13, for example, the operation assistance apparatus may have some of the structural elements shown in FIG. 1.

FIG. 13 depicts a block diagram showing a functional structure of the operation assistance system in Modification 2 according to the embodiment of the present invention. In FIG. 13, the operation assistance apparatus 100 includes the operation screen generating unit 102, the operation screen sharing unit 105, the operation assistance video recording unit 106, the operation assistance video reproducing unit 110, and the display control unit 111. Here, the input unit 101, the display 103, and the storage unit 108 are connected to the operation assistance apparatus 100 via various interfaces. Moreover, the operation screen sharing unit 105 works as the transmitting and receiving unit 104.

Even though structured as shown in FIG. 13, in the case where the operation screen is not shared with the communications terminal, the operation assistance apparatus 100 can automatically cause the display 103 to provide, depending on the current operation screen, an operation assisting image recorded when the operation screen was previously shared with a communications terminal. Accordingly, the operation assistance apparatus 100 can effectively assist an assistance recipient.

Furthermore, the operation assistance apparatus 100 may be a computer including a central processing unit (CPU), read only memory (ROM), random access memory (RAM), and a hard disk. Here, the computer carries out the functions of the operation assistance apparatus 100 by causing the CPU to execute a computer program held in the ROM or the RAM to execute.

Part or all of the functional elements included in the operation assistance apparatus 100 according to the above embodiment may be configured from a single system large-scale integration (LSI). As shown in FIG. 13, for example, the operation assistance apparatus 100 may include a system LSI 120 having the operation screen generating unit 102, the operation screen sharing unit 105, the operation assistance video recording unit 106, the operation assistance video reproducing unit 110, and the display control unit 111

The System-LSI 120 is a super-multi-function LSI manufactured by integrating constituent units on one chip, and is specifically a computer system configured by including a microprocessor, a ROM, a RAM, and so on. A computer program is stored in the RAM. The System-LSI 120 performs its functions through the microprocessor's operation according to the computer program.

Here, the system-LSI is mentioned but there are instances where, due to a difference in the degree of integration, the designations IC, LSI, super LSI, and ultra LSI are used. Furthermore, the means for circuit integration is not limited to the LSI, and implementation in the form of a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces the LSI appears thorough progress in semiconductor technology or other derived technology, that technology can naturally be used to carry out integration of the constituent elements. Biotechnology can be applied to the integrated circuit technology.

The present invention may be implemented as an operation assistance apparatus including such characteristic processing units; instead, the present invention may also be implemented as an operation assistance method including the characteristic processing units in the operation assistance apparatus as steps. Moreover, the present invention may be implemented as a computer program causing a computer to execute each of the characteristic steps included in the operation assistance method. As a matter of course, such a computer program may be distributed via a computer-readable, storage medium such as a compact disc read only memory (CD-ROM), and a communications network such as the Internet.

### INDUSTRIAL APPLICABILITY

An operation assistance apparatus according to an aspect of the present invention can efficiently display an operation assistance video which holds the same operation screen as the current operation screen on which the assistance recipient is operating on, and which is recorded when an assistant previously gives the operation assistance. The operation assistance apparatus is effective for use in TVs, HDD recorders or home servers that require complex operations.

### REFERENCE SIGNS LIST

10 Operation assistance system

100 Operation assistance apparatus

101 and 151 Input unit

102 Operation screen generating unit

103 and 153 Display

104 Transmitting and receiving unit

105 Operation screen sharing unit

106 Operation assistance video recording unit

107 Operation assistance video managing information recording unit

108 Storage unit

110 Operation assistance video reproducing unit

111 Display control unit

120 System LSI

150 Communications terminal

211, 212, 213, 214, 221, 222, 223, 231, 232, 233, 234, 241, 242, and 501 Operation screen

300 Operation assistance video file

301 Header region

302 Data region

407 Operation assistance video managing information

401 Operation assistance video ID

402 Assistant's name

403 Operation assistance title

404 Operation screen switching information

405 Operation screen ID

406 and 409 Time stamp information

407 Video location information

408 Operation assistance information

410 Operation information

502 and 503 Auxiliary screen

701, 702, and 704 Operation image

703 Operation text message

1. An operation assistance apparatus which includes a screen sharing unit that transmits data of an operation screen to a communications terminal so as to share the operation screen with the communications terminal, the operation screen working as a graphical user interface (GUI), the screen sharing unit being connected with the communications terminal via a network, and said operation assistance apparatus comprising:
a screen generating unit configured to generate the operation screen according to a user operation received via an input unit;
a video recording unit configured to record the operation screen to generate video data, and to store the video data in a storage unit, in the case where the operation screen is shared with the communications terminal;
a display control unit configured to cause a display unit to provide the operation screen; and
a video reproducing unit configured to retrieve video data corresponding to the operation screen from among the video data stored in the storage unit by said video recording unit, and to reproduce the retrieved video data, in the case where the operation screen is not shared with the communications terminal,
wherein in the case where the operation screen is not shared with the communications terminal, said display control unit is configured to cause the display unit to simultaneously provide the operation screen and an operation assistance video which the reproduced video data shows.

2. The operation assistance apparatus according to claim 1, further comprising
an operation information recording unit configured to store operation information in the storage unit in association with the generated video data, the operation information showing details of an operation carried out to the operation screen,
wherein said video reproducing unit is further configured to read from the storage unit the operation information corresponding to the retrieved video data, and
when causing the display unit to provide the operation assistance video, said display control unit is configured to cause the display unit to provide the operation information read by said video reproducing unit.

3. The operation assistance apparatus according to claim 2,
wherein the input unit is a touch panel and is configured to provide, as the operation information, information indicating a touch location on a touch area of the touch panel.

4. The operation assistance apparatus according to claim 3,
wherein said display control unit is configured to cause the display unit to provide the operation information by having a predetermined operation image overlap an area found in the operation assistance video and corresponding to the touch location indicated with the operation information, so that a time when the operation information is provided and a time when the operation screen is recorded synchronize with each other.

5. The operation assistance apparatus according to claim 2,
wherein the input unit is a remote controller having multiple operation keys and is configured to provide, as the operation information, information for specifying an operation key which a user operates among the operation keys.

6. The operation assistance apparatus according to claim 5,
wherein said display control unit is configured to cause the display unit to provide the operation information by causing the display unit to provide an operation image showing the operation key specified by the operation information, so that a time when the operation information is provided and a time when the operation screen is recorded synchronize with each other.

7. The operation assistance apparatus according to claim 1,
wherein in the case where said video reproducing unit reads multiple pieces of the video data, said display control unit is configured to cause the display unit to simultaneously provide the operation screen and multiple operation assistance videos shown by the pieces of the video data.

8. The operation assistance apparatus according to claim 1,
wherein in the case where said video reproducing unit reads multiple pieces of the video data, said display control unit is configured to cause the display unit to simultaneously provide the operation screen and multiple operation assistance videos shown by the pieces of the video data so that the operation assistance videos are sequentially provided.

9. The operation assistance apparatus according to claim 1, further comprising
an input unit configured to receive from the user an operation for changing a reproduction status of the operation assistance video provided on the display unit, and
said video reproducing unit is configured to change a reproduction status of the video data according to the received operation for changing the reproduction status.

10. The operation assistance apparatus according to claim 1,
wherein said display control unit is configured to cause the display unit to simultaneously provide the operation screen and the operation assistance video, by causing the display unit to provide the operation assistance video in part of an area in which the operation screen is provided.

11. The operation assistance apparatus according to claim 1,
wherein said video reproducing unit is configured to repeat reproducing the video data.

12. The operation assistance apparatus according to claim 1,
wherein in the case where a first operation screen is generated before the operation screen and a second operation screen is the operation screen, said video reproducing unit is configured to read from the storage unit video data of the second operation screen as video data corresponding to the operation screen, the video data of the second operation screen being recorded when the first operation screen transits to the second operation screen.

13. The operation assistance apparatus according to claim 1 provided in a form of an integrated circuit.

14. An operation assistance method for transmitting data of an operation screen to a communications terminal so as to share the operation screen with the communications terminal, the operation screen working as a graphical user interface (GUI), the screen sharing unit being connected with the communications terminal via a network, and said operation assistance method comprising:
generating the operation screen according to a user operation received via an input unit;
recording the operation screen to generate video data, and storing the video data in a storage unit, in the case where the operation screen is shared with the communications terminal;
causing a display unit to provide the operation screen; and
retrieving video data corresponding to the operation screen from among the video data stored in the storage unit in said recording, and reproducing the retrieved video data, in the case where the operation screen is not shared with the communications terminal,
wherein in the case where the operation screen is not shared with the communications terminal, said causing the display unit involves simultaneously providing the operation screen and an operation assistance video which the reproduced video data shows.

15. A non-transitory computer-readable recording medium for use in a computer, said recording medium having a computer program recorded thereon for causing the computer to execute said operation assistance method according to claim 14.
